(19) United States
(12) Patent Application Publication
(10) Pub. No.: US 2022/0403238 A1
(43) Pub. Date: Dec. 22, 2022

(54) Blue to UV Up-Converter Comprising Lanthanide Ions such as Pr3+ Activated Garnet and its Application for Surface Disinfection Purposes

(71) Applicant: Evonik Operations GmbH, Essen (DE)

(72) Inventors: Stefan FISCHER, Soest (DE); David Böhnisch, Kirchheim am Neckar (DE); Thomas Jüstel, Witten (DE); Simone Schulte, Essen (DE); Markus Hallack, Schermbeck (DE)

(73) Assignee: Evonik Operations GmbH, Essen (DE)

(21) Appl. No.: 17/754,777

(22) PCT Filed: Oct. 5, 2020
(86) PCT No.: PCT/EP2020/077796

§ 371 Date: Apr. 12, 2022

(30) Foreign Application Priority Data
Oct. 14, 2019 (EP) 19202897.5

(51) Int. Cl. C09K 11/77; A61L 2/10; A61L 2/08

(52) U.S. Cl. CPC C09K 11/7774; C09K 11/77744; A61L 2/10; A61L 2/088; C09K 11/77742

(57) ABSTRACT

A garnet is doped with a lanthanide ion selected from praseodymium, gadolinium, erbium, and neodymium. For co-doping, at least two of the lanthanide ions are selected. The lanthanide ion doped garnet converts electromagnetic radiation energy of a longer wavelength of below 530 nm to electromagnetic radiation energy of shorter wavelengths in the range of 220 to 425 nm. The garnet is crystalline and is obtainable from a mixture of salts or oxides of the components, in the presence of a chelating agent, that are dissolved in acid. This is followed by a specific calcination process to produce the garnet and, optionally, to adjust particle size and increase the crystallinity of the particles. The garnet can be used to inactivate microorganisms or cells covering a surface containing silicate-based material under exposure of electromagnetic radiation energy of a longer wavelength of below 500 nm.

A garnet doped with lanthanide ions, wherein the lanthanide ions are selected from praseodymium, gadolinium, erbium, neodymium, yttrium and for co-doping at least two of them, wherein the lanthanide ion doped garnet converts electromagnetic radiation energy of a longer wavelength of below 530 nm to electromagnetic radiation energy of shorter wavelengths in the range of 220 to 425 nm. Further the garnet is crystalline and is obtainable from a mixture of salts or oxides of the components in the presence of a chelating agent that are dissolved in acid followed by a specific calcination processes to produce the garnet and optionally to adjust particle sizes and increase the crystallinity of the particles in particular in the same process. The garnet can be used to inactivate microorganisms or cells covering a surface under exposure of electromagnetic radiation energy of a longer wavelength of below 500 nm.

Since the invention of efficiently blue or UV-A emitting (In,Ga)N semiconductor materials (365-500 nm), inorganic solid state light sources have outperformed other lighting technologies such as incandescent and discharge lamps and thus indoor and, in the meantime also outdoor lighting is dominated by phosphor converted light emitting diodes (pcLEDs) utilizing the inorganic semiconductor material (In,Ga)N as the primary radiation source.

It is expected that this situation will settle for the next decades and that light sources relying on blue emitting (In,Ga)N LEDs as primary radiation source will penetrate into and dominate all kind of lighting application areas, e.g. indoor, outdoor, advertisement, architecture, decoration, special, and street lighting.

Therefore, indoor illumination will rely on semiconductor light sources, with an emission band between 400 and 480 nm, which will partly be converted by inorganic phosphors into other colours to obtain white light. However, depending on the colour temperature aimed at about 5 to 10% of the overall power distribution will remain in the blue spectral range, which in turn means that this radiation can enforce the excitation of an illuminated up-converter to obtain UV radiation at the point of illumination.

Recently, this opportunity caused dedicated R&D projects in aiming at the identification of efficient blue to UV-C up-conversion materials, such as Y₂SiO₅:Pr,Gd,Li and some other. The main problem of materials discovered and published so far is their rather low up-conversion efficiency, which is just above the detection level or signal to noise ratio.

What is really wanted is an up-converting material, which enables the significant reduction of microorganisms within a period typical for daylight illumination, i.e. within a few hours, so that a daily reduction of microorganisms can be effectively achieved. Moreover, the material must be non-hazardous to the environment and should show an operational lifetime of at least 10000 hours. Finally, the material must be cost-effective and recyclable to achieve a wide penetration into such surface coatings.

Further, the efficiency of the up-conversion material must therefore be much better than of the known materials as only the remaining 5 to 10% of the overall power distribution in the LED remain in the blue spectral range and shall be used to enforce the excitation of an illuminated up-converter to obtain UV radiation at the point of illumination.

Subject of the current invention is therefore to furnish a blue/green to UV radiation up-converting inorganic material with an increased efficiency as well as a process for the production of that material.

The problem is solved by the disclosed novel blue/green to UV radiation up-converting garnet doped or co-doped with lanthanide selected from praseodymium, gadolinium, erbium, neodymium, yttrium and for co-doping at least two of them or by a mixture of garnets, the process to produce the garnet and its application in coatings, surfaces of matrix materials, thin film, composite layers. Particularly preferred embodiments are disclosed in the depended claims and in the description.

A garnet according to the invention is able to convert electromagnetic radiation energy of a longer wavelength to electromagnetic radiation energy of a shorter wavelength, in particular the electromagnetic radiation energy of at least one longer wavelength of below 530 nm is converted to electromagnetic radiation energy of at least one shorter wavelength in the range of 220 to 425 nm.

Subject of the invention is to provide an UV emitting garnet, in particular a garnet that is able to emit electromagnetic radiation energy at a wavelength in the range of 220 to 425 nm, in particular of 240 nm to 320 nm, most preferred with at least one maximum in the range of 250 to 320 nm. A further subject of the invention is to provide a composition or a film comprising at least one type of photoluminescent inorganic microscale particles of a garnet, in compositions or film for self-disinfection purposes. The particles of the garnet are able to convert blue to green (380-550 nm) photons into UV photons, a process which is known as up-conversion.

In particular the particles of the garnet possess a crystallinity of greater than 70%, in particular equal or greater than 95%.

According to a main aspect of the invention the UV emitting garnet doped with lanthanide ions, in particular the garnet is able to emit electromagnetic radiation energy at a wavelength (shorter wavelength) in the range of 220 to 425 nm, in particular of 240 nm to 350 nm, and is preferably not harmful to microorganisms without being irradiated, in particular without being irradiated with a wavelength in the range of 450 nm and longer wavelength, in particular in the range of 450 nm to 530 nm. Irradiation of the UV emitting garnet doped with lanthanide ions with a wavelength in the range of 450 nm and longer wavelength, in particular in the range of 450 nm to 530 nm, induces emission of electromagnetic radiation energy at a wavelength (shorter wavelength) in the range of 250 to 425 nm, in particular of 250 nm to 350 nm, that is harmful to microorganisms.

The invention was realized by the use of a Pr³⁺ doped and optionally Gd³⁺ co-doped garnet as host lattice in which
blue light (wavelength below 500 nm) is absorbed via transitions from the ³H₄ level of the ground state configuration [Xe]₄f² of Pr³⁺ to the ³P_{0,1,2} excited states. The photon energy corresponds to photons with a wavelength in the range from 440 to 490 nm.
In a second step, after relaxation into the ³P₀ level, excited state absorption causing the population of the excited state configuration [Xe]4f¹5d¹ takes place, by utilizing again the blue pump source. This requires crystal-field components of the excited state configuration [Xe]4f¹5d¹ located in the spectral range of 220 to 250 nm. Suitable luminescent materials must thus exhibit a suitable crystal-field splitting to obtain excited 5d-states in this spectral range, and are claimed.
After excitation, the lowest crystal-field component of the excited state configuration [Xe]4f¹5d¹ return upon emitting a photon to the ground state, resulting in UV radiation.

Co-doping of the claimed garnet by Gd³⁺ leads to energy transfer between Pr³⁺ and Gd³⁺ and subsequently to main emission at 311 nm.

Presently, pcLEDs are the most efficient white light sources and thus widespread in all kind of general lighting applications. The wall-plug efficiency of best practice cool white pcLEDs is almost 60% and the radiant flux is in the range of a few optical Watts per pcLED. Since up-conversion processes can yield an efficiency of about 25% and indoor illumination requires at least 500 lm/m² or 5 W/m² (for a light source with 100 lm/W), the process is of tremendous interest to use the blue to green part of the emission spectrum for so-called low-dose disinfection of surfaces.

One preferred embodiment of the invention concerns Pr³⁺ activated garnets optionally co-doped with Gd³⁺, wherein the garnet may be selected from lutetium-aluminium garnet, yttrium-aluminium garnet (YAG), silicate [Si₃O₁₂] garnet and/or an aluminium-silicate garnet.

According to a preferred embodiment the garnet doped with a lanthanide ion, wherein lanthanide ion is selected from praseodymium, gadolinium, erbium, neodymium, yttrium, and for co-doping at least two of them. The lanthanide ions as doping are selected from praseodymium(III+), gadolinium(III+), erbium(III+) and neodymium(III+) and for co-doping a second different lanthanide(III+) ion selected from praseodymium(III+), gadolinium(III+), erbium(III+), yttrium(III+) and neodymium(III+) is used. Particularly preferred as doping is praseodymium(III+) or at least comprising praseodymium(III+) and a second Lanthanide(III+) ion for co-doping. Wherein the mentioned lanthanide ions(III+) are activators for the up-conversion.

Further according to one embodiment of the invention a garnet doped with lanthanide ions for converting electromagnetic radiation energy of a longer wavelength to electromagnetic radiation energy of shorter wavelength, is obtainable according to the process of the invention comprising lanthanide ions selected from praseodymium, gadolinium, erbium, neodymium, yttrium and for co-doping at least two of them, and, wherein the garnet doped with lanthanide ions, preferred Ln³⁺, comprises above 95% Ln³⁺ lanthanide ions and less than 5% Ln⁴⁺ lanthanide ions, in respect to all Ln ions (sum up to 100%).

According to particular preferred embodiment the garnet is selected from the following garnets:

i) the garnet comprises lutetium on a position of the crystal lattice and this position in the crystal lattice is doped with different lanthanide ions selected from praseodymium, gadolinium, erbium, neodymium, yttrium and for co-doping at least two of them, or

ii) the garnet is a lutetium-aluminium garnet that is doped with different lanthanide ions selected from praseodymium, gadolinium, erbium, neodymium, yttrium and for co-doping at least two of them, or

iii) the garnet is a yttrium-aluminium garnet (YAG) that is doped with different lanthanide ions selected from praseodymium, gadolinium, erbium, neodymium, yttrium and for co-doping at least two of them, or

iv) the garnet is a silicate [Si₃O₁₂] garnet or an aluminium-silicate garnet that is doped with different lanthanide ions selected from praseodymium, gadolinium, erbium, neodymium, yttrium and for co-doping at least two of them. Particular preferred in the garnet are lanthanide ions selected from praseodymium, gadolinium, erbium, neodymium, and optional yttrium and for co-doping at least two of them with 0.1 to 5 mol-% in the crystal lattice of the garnet, of the relevant place in the crystal lattice (place in crystal lattice sums up to 100 mol-%) in the garnet. This means lanthanide ions as index comprise 0.001 to 0.05 of 1 place in the crystal lattice, in particular as index b (index b=1/100·mol-%).

Therefore, the XRPDs of the inventive garnets should in particular comply with XRPDs of known non-doped garnets listed in ICDD-database or with calculated XRPD as a reference.

According to a most preferred aspect of the invention the lanthanide ions are selected from praseodymium(III+) (Pr³⁺), gadolinium (III+) (Gd³⁺), erbium (III+) (Er³⁺) and neodymium (III+) (Nd³⁺), yttrium(III+), preferred praseodymium(III+) (Pr³⁺), gadolinium (III+) (Gd³⁺) and yttrium(III+), and a co-doping of at least two of them, and optionally the amount of lanthanide ions (IV+) is less than 0.5 mol-%, in particular less than 0.1 mol-%, preferred less than 0.05 mol.-% or less than 0.01 mol-%, of the relevant place in the crystal lattice (place in crystal lattice sums up to 100 mol-%) in the garnet.

In a preferred embodiment i) the garnet is not a hydrate, in particular the garnet is free from water of crystallization, and/or ii) the garnet is free from hydroxyl-groups. Free from hydroxy-groups is a garnet that possesses no hydroxyl-groups covalently bond to an atom at a position in the crystal lattice. Water or hydroxyl-groups on the surface of the garnet are not considered as hydroxyl-groups according to ii). Nevertheless, the content of water and hydroxyl-groups should be as low as possible.

According to particular preferred embodiment the crystallinity of the Garnet is greater than 70%, in particular equal of greater than 80%, 90%, more preferred equal or greater than 95%, 98%, most preferred equal to greater than 99%. The crystallinity may be evaluated by a method known to the skilled person (crystallographer) using Rietveld analysis (Madsen et al., Description and survey of methodologies for the determination of amorphous content via X-ray powder diffraction, Z. Kristallographie 226 (2011) 944-955).

In addition, the garnet is in particular free from amorphous phases, wherein free from amorphous phases in the garnet means less than 5%, preferred less than 2%, most preferred less than 1%, 0.01%, 0.001%, 0.0001% (analysis (XRPD, Rietveld-refinement).

Most preferred are garnets of a crystalline pure phase (free from phase shift).

According to one aspect of the invention garnet are preferred, wherein the garnet is doped with lanthanide ions is selected from garnets free from crystal water, crystal solvates with —OH functionality. In particular the garnet doped with lanthanide ions, preferred Ln³⁺, most preferred above 95% Ln³⁺ and less than 5% Ln⁴⁺, is selected from garnets that are free from stoichiometric hydrates and/or solvates and has a crystallinity of greater than 70%.

The garnets can be also described with idealised formulas according to the following examples. A garnet, in particular the composition of a garnet, may be selected from the idealised general formula I

Lu_{3-a-b-n}Ln_{b}(Mg_{1-z}Ca_{z})ₐLiₙ(Al₁₋ᵤ₋ᵥGaᵤScᵥ)₅₋ₐ₋₂ₙ(Si_{1-d-e}Zr_{d}Hfₑ)ₐ₊₂ₙO₁₂ I

wherein a=0-1, preferred 0-0.5, 1≥b>0, in particular b=0.00001-0.5, preferred b=0.001-0.2, more preferred b=0.005-0.1, d=0-1, e=0-1, n=0-1, z=0-1, u=0-1, v=0-1, with u+v≤1 und d+e≤1;

and as activator or doping Ln=praseodymium (Pr), gadolinium (Gd), erbium (Er), neodymium (Nd), yttrium (Y); Lu=lutetium, Li=lithium.

Further preferred garnets are selected from the idealised general formula Ia

(Lu_{1-x-y}YₓGd_{y})_{3-a-b-n}Ln_{b}(Mg_{1-z}Ca_{z})ₐLiₙ(Al₁₋ᵤ₋ᵥGaᵤScᵥ)₅₋ₐ₋₂ₙ(Si_{1-d-e}Zr_{d}Hfₑ)ₐ₊₂ₙO₁₂ Ia

wherein a=0-1, preferred 0-0.5, 1≥b>0, in particular b=0.00001-1, preferred 0.0001-0.2, d=0-1, in particular d=0.001 to 0.5, e=0-1, in particular e=0.001 to 0.5, n=0-1, x=0-1, in particular x=0.001 to 0.5, y=0-1, in particular 0.001 to 0.3, z=0-1, u=0-1, v=0-1, with x+y≤1, u+v≤1 and d+e≤1; and wherein in formula Ia Ln=praseodymium (Pr), erbium (Er), neodymium (Nd); Lu=lutetium, Gd=gadolinium, Y=Yttrium, Li=lithium.

Wherein in all idealized formula indices x+y≤1, u+v≤1 and d+e≤1.

According to further embodiment of the invention the composition of a garnet can be selected form one of the following idealised general formulas:

i) formula Ib

(Lu_{1-x-y}YₓGd_{y})_{3-b}Ln_{b}(Al₁₋ᵤ₋ᵥGaᵤScᵥ)₅O₁₂ Ib

with Ln_{b} is Ln=Pr and b=0.001-0.05, x=0-1, y=0-1, u=0-1, v=0-1,

ii) formula Ic

(Lu_{1-x-y}YₓGd_{y})_{3-b-a}Ln_{b}(Mg_{1-z}Ca_{z})ₐAl₅₋ₐSiₐO₁₂ Ic

with Ln_{b} is Ln=Pr, 1 b>0, in particular b=0.001-0.5, preferred b=0.001-0.05, a>0, x=0-1, y=0-1, z=0-1,

iii) formula Id

(Lu_{1-x-y}YₓGd_{y})_{2-b}Ln_{b}(Ca_{1-z}Mg_{z})Al₄(Zr_{1-f}Hf_{f})O₁₂ Id

with Ln_{b} is Ln=Pr, 0.5 b>0, in particular b=0.001-0.5, preferred b=0.001-0.05, x=0-1, y=0-1, z=0-1, f=0-1 or formula Id*

(Lu_{1-x-y}YₓGd_{y})_{1-b}Ln_{b}(Ca_{1-z}Mg_{z})₂Al₃(Zr_{1-f}Hf_{f})₂O₁₂ Id*

with Ln_{b} is Ln=Pr, b>0, in particular b=0.001-1, preferred b=0.001-0.05, x=0-1, y=0-1, z=0-1, f=0-1.

Indices a, d, e, x, y, and z can vary in the range of 0 to 1 with all values up to four decimal places, and b can vary between b greater than zero up to 1, in particular b greater than zero up to 0.5 with up to four decimal places.

Preferred garnets can be described with formulas I, la, Ib, Ic, Id and Id*, wherein i) 1≥b>0, preferred 0.5≥b>0, and a=0, ii) a+b=1 and z=1 or iii) a+b=1 and z=0 or iv) a+b=1 and 0<z<1, wherein x=0 and y=0 and all remaining indices are as disclosed above.

Preferred garnets can be described with formula Ib, wherein i) 0.05≥b>0, and y=0, ii) b>0 and 1>y>0, x=0, or iii) b>0 and 1>y>0 and 1>y>0, and x+y<1, wherein all remaining indices are as disclosed above, with x+y≤1, u+v≤1 and d+e≤1.

Preferred garnets can be described with formulas Ic, wherein i) 0.05≥b>0, 1, ii) 0.05≥b>0, 1 and 0<z<1, wherein all remaining indices are as disclosed above, with x+y 1, u+v≤1 und d+e≤1.

Preferred garnets can be described with formulas Id or Id*, wherein i) 0.05≥b>0, ii) 0.05≥b>0 and 0<z<1, f=0-1, wherein all remaining indices are as disclosed above, with x+y≤1, u+v≤1 and d+e≤1.

Also, subject of the invention is a garnet or garnets doped with praseodymium and that is optional co-doped with gadolinium selected from the below mentioned list. It has surprisingly, turned out that these garnets show rather efficient blue to UV radiation up-conversion.

Particular preferred garnets or mixtures of garnets are selected from the following idealised general formulas

(Lu_{1-x-y}YₓGd_{y})_{3-b}Pr_{b}(Al₁₋ᵤGaᵤ)_{5-b}O₁₂

(Lu_{1-x-y}YₓGd_{y})_{3-b}Pr_{b}(Al₁₋ᵤScᵥ)_{5-b}O₁₂

(Lu_{1-x-y}YₓGd_{y})_{3-b}Pr_{b}(Ga₁₋ᵤScᵥ)₅O₁₂

(Lu_{1-x-y}YₓGd_{y})₂Pr_{b}CaAl₄SiO₁₂

(Lu_{1-x-y}YₓGd_{y})Pr_{b}Ca₂Al₃Si₂O₁₂

(Lu_{1-x-y}YₓGd_{y})₂Pr_{b}MgAl₄SiO₁₂

(Lu_{1-x-y}YₓGd_{y})Pr_{b}Mg₂Al₃Si₂O₁₂

(Lu_{1-x-y}YₓGd_{y})₂Pr_{b}CaAl₄(Zr_{d}Hfₑ)O₁₂

(Lu_{1-x-y}YₓGd_{y})Pr_{b}Ca₂Al₃(Zr_{d}Hfₑ)₂O₁₂

(Lu_{1-x-y}YₓGd_{y})₂Pr_{b}MgAl₄(Zr_{d}Hfₑ)O₁₂

(Lu_{1-x-y}YₓGd_{y})Pr_{b}Mg₂Al₃(Zr_{d}Hfₑ)₂O₁₂

wherein b=0.001-0.05, u=0-1, v=0-1, x=0-1, y=0-1.

Further preferred embodiments comprise garnets, wherein the garnet is a solid solution doped with lanthanide ions comprising at least one earth alkali ion and/or at least one alkali ion.

A preferred garnet converts electromagnetic radiation energy of a longer wavelength of below 500 nm, in particular from below 500 nm to 410 nm, to electromagnetic radiation energy of shorter wavelengths in the range of 230 nm to 400 nm, in particular wherein the intensity of the emission maximum of electromagnetic radiation energy of shorter wavelengths has an intensity of at least 1·10³ counts/(mm²*s), in particular more than 1·10⁴ counts/(mm²*s), preferred more than 1·10⁵ counts/(mm²*s), most preferred more than 1·10⁶ counts/(mm²*s). Wherein the emission spectra is excited with a laser, in particular a laser with an efficiency of 75 mW at 445 nm and/or an efficiency of 150 mW at 488 nm.

Preferred maxima of the converted electromagnetic radiation energy are in the range of 250 to 350 nm, in particular with maxima at least at about 265 nm. Also preferred is at least one maxima in the range of 270 to 330 nm, most preferred in the range of 280 to 330 nm.

According to the invention up-conversion means the conversion of electromagnetic radiation energy of a longer wavelength, in particular below 500 nm, most preferred in the range of 440 to 490 nm, into electromagnetic radiation energy of a shorter wavelength, in particular in the range of 220 to 425 nm, preferred in the range of 250 to 350 nm.

Garnets according to the invention doped with lanthanide ions may be capable to reduce the concentration of microorganisms at the surface upon solar light or LED lamp illumination.

According to another aspect of the invention the garnet is preferably a solid solution of a garnet doped with lanthanide ions comprising at least one alkali ion or at least one earth alkali ion, in particular the garnet is doped with praseodymium and optionally co-doped with gadolinium. Particular preferred are garnets doped with lanthanide selected from praseodymium and optionally gadolinium ions comprising at least one alkali ion selected from Li, Na, K, Rb, Cs, preferred selected from Li and optionally Na or K, most preferred selected from Li, or comprising at least one earth alkali ion selected from Mg, Ca, Sr, Ba, preferred selected from Ca an Mg. Most preferred are the above mentioned garnets, wherein the crystallinity is equal or above 90%, preferred equal or above 95%, and wherein the mean particle size D₅₀ is in the range of 1 micro meter to 20 micro meter, preferred in the range of 2 to 15 micro meter, more preferred in the range of 5 to 15 micro meter.

Particular preferred garnets are: (Lu_{0.99}Pr_{0.01})₃Al₅O₁₂, (Lu_{0.985}Pr_{0.015})₂CaAl₄SiO₁₂, (Lu_{0.99}Pr_{0.01})₃Ga₂Al₃O₁₂, (Lu_{0.99}Pr_{0.01})₃ScAl₄O₁₂, (Lu_{0.99}Pr_{0.01})₂LiAl₃Si₂O₁₂. For example, (Lu_{0.99}Pr_{0.01})₃Al₅O₁₂ shows emissions at 275 to 420 nm, in particular with maxima at 300 to 350 nm (FIG. 8), and (Lu_{0.985}Pr_{0.015})₂CaAl₄SiO₁₂ with emissions at 275 to over 400 nm, in particular with a maximum at 300 to 320 nm, see FIG. 9. (Lu_{0.99}Pr_{0.01})₂LiAl₃Si₂O₁₂ possesses a maximum in the range of 300 to 340 nm.

According to one aspect of the invention the garnet, in particular comprising a composition selected from one of the formulas I, la, Ib, Ic, Id and Id*, wherein (Ln) lanthanide ions selected from praseodymium, gadolinium, erbium, neodymium or a co-doping comprising at least two of them, in particular preferred are praseodymium and optionally gadolinium, and, wherein the garnet possesses XRPD signals, in particular signals with a high intensity, in the range of 17° 2Θ to 19° 2Θ and of 31° 2Θ to 35° 2Θ, in particular in the range of 17° 2Θ° to 19° 2Θ and of 33° 2Θ to 35° 2Θ, wherein, in particular signals are measured according with a Bragg-Brentano geometry using Cu-Kα radiation.

To increase the emission, a certain particle size is most preferred. Therefore, the disclosed materials are claimed as p-scale, sub-p-scale to nanoscale particles in the range from 10 nm to 100 μm.

The particle sizes of the garnet is preferably in the range of 1 micro meter to 100 micro meter (μm), more preferred in the range from 1 micro meter to 50 micro meter (μm), more preferred from 1 micro meter to 20 micro meter (μm).

Preferably the mean particle size (D₅₀) of the garnet is preferably in the range of 1 micro meter to 100 micro meter (μm), more preferred in the range from 1 micro meter to 50 micro meter (μm), most preferred from 1 micro meter to 20 micro meter (μm). More preferably the mean particle size (D₅₀) of the silica-based crystalline material is in the range of 2 micro meter to 20 micro meter (μm), more preferred in the range from 5 micro meter to 20 micro meter (μm), most preferred of 5 micro meter to 15 micro meter (μm), in particular about 10 micro meter and −/+5 micro meter. According to one particular preferred embodiment the particle size distribution is D₁₀ 2 to 5 micro meter, D₅₀ 5 to 15 micro meter and D₉₀ below 20 micro meter, preferred below 18 micro meter. in an alternative the particle size distribution is D₁₀ 1 to 2 micro meter, D₅₀ 2 to 10 micro meter and D₉₀ below 20 micro meter, preferred below 18 micro meter. The particle size distribution was determined with dynamic laser light scattering, using a Horiba LA-950-V2 organic particle size analyser.

All inventive garnets comprise at least the trivalent activator Pr³⁺, which ground state configuration [Xe]4f² delivers 13 ^{S}L_{J} levels located below the lowest crystal-field component of the excited configuration [Xe]4f¹5d¹. By the proper choice of the host material the lowest crystal-field component of the excited configuration of Pr³⁺ can be adjusted at 35000 to 40000 cm⁻¹ above the ground state level ³H₄ belonging to the ground state configuration. In this way, a two-photon absorption process at a single ion is enabled, which in turn can result in the emission of a UV photon.

Particularly a Pr³⁺ doped garnet according to the invention and treaded according to the invention, deliver blue to UV radiation up-converter materials, which are much more efficient than those published in patent and peer-reviewed literature so far.

According to a further subject of the invention a lanthanide doped garnet or a mixture of garnets are claimed that possess crystal-field components of the excited state configuration [Xe]4f¹5d¹ located in the spectral range from 220 to 250 nm.

Also subject of the invention is a process for the production of a garnet as well as a garnet or a mixture of garnets obtainable according to the process, wherein the process comprising the steps of

i) providing at least one lanthanide salt or lanthanide oxide, in particular selected from lanthanide nitrate, lanthanide carbonate, lanthanide carboxylate, lanthanide acetate, lanthanide sulphate and/or lanthanide oxide or a mixture of at least two of them, wherein the lanthanide ion in the lanthanide oxide and/or lanthanide salt is selected from praseodymium, gadolinium, erbium, neodymium and a mixture of at least two of them,

ii) providing an element for the crystal garnet lattice selected from a lutetium, silicon, aluminium, yttrium source, wherein the source is selected from

a) at least one lanthanide salt or lanthanide oxide, in particular selected from lanthanide nitrate, lanthanide carbonate, lanthanide carboxylate, lanthanide acetate, lanthanide sulphate and/or lanthanide oxide or a mixture of at least two of them, preferably wherein the lanthanide ion in the lanthanide oxide and/or lanthanide salt is lutetium, and/or

b) Si source, in particular tetra-Isopropylsilicate, Tetraethoxysilan, Tetramethoxysilan, silica, silicate, or a mixture of at least two of them, and/or

c) aluminium source, in particular selected from aluminium nitrate, aluminium carbonate, aluminium carboxylate, aluminium acetate, aluminium sulphate, aluminium oxide and/or aluminium hydroxid or a mixture of at least two of them, and/or

d) yttrium salt or yttrium oxide or a mixture,

iii) optionally providing at least one earth alkali salt and/or earth alkali oxide, and/or

iv) optionally providing at least one alkali salt, in particular selected from lithium salt or any lithium compound and optional selected from sodium salt and potassium salt, preferred the salt of the lithium salt is selected from ii) and is a lithium silicate,

v) providing a chelating agent, in particular selected from hydroxy acid, citric acid, hydroxy amino alkyl, in particular citric acid and/or tris(hydroxymethyl)aminomethane,
dissolving i), ii), iii), iv), v) and iv) and optional vi) in acid, in particular in mineral acid or a mixture of mineral acids,
evaporation of the of acid and optionally of the chelating agent at elevated temperature, in particular above 50° C., preferred above 60° C., optional under stirring,
obtaining a concentrated reaction product, wherein the concentrated reaction product is dried by heating the product above 100° C., in particular i) above 120° C. or ii) above 250° C., obtaining a further product,
the further product is heated up to at least 600° C., in particular preferred up to at least 750° C., preferred up to at least 800° C., 1000° C. for 1 to 10 h, in particular for 3 to 5 h, preferred for 4 hours, to remove organic residues and obtaining a product with reduced organic content,
heating the product with reduced organic content up to at least 1200° C., in particular up to 1400° C., preferred up to at least 1550° C., optionally for 0.5 to 10 h, preferred for 0.75 to 6 h, preferred is a heating of the product with reduced organic content up to at least 1200° C. at a temperature sufficient for crystallization,
cooling down and,
obtaining lanthanide ion doped garnet.

In two preferred alternatives at least one earth alkali source, such as an earth alkali salt and/or earth alkali oxide or an alkali source, such as at least one alkali salt selected from lithium salt or any lithium compound and optional selected from sodium salt and potassium salt, preferred the salt of the lithium salt is selected from ii) and is a lithium silicate. Earth alkali comprise all alkaline earth metals, in particular magnesium, calcium, strontium and barium. Alkali metals comprise K, Na, Li, Rb and Cs, in particular K, Na and Li.

Non limiting examples for d) yttrium salts or yttrium oxides or a mixture comprising at least one of them are: Y₂O₃, Y(NO₃)₃, Y₂(SO₄)₃, Y(acetate)₃, Y₂(oxalate)₃, Y₂(CO₃)₃, Y(citrate), Y(OH)₃, (NH₄)Y(tartrate)₂. Non limiting examples for iii) earth alkali salts and/or earth alkali oxides are: CaCO₃, CaSO₄, Ca(NO₃)₂, CaCl₂), CaC₂O₄, Ca(tartrate), CaHPO₄, MgCO₃, MgSO₄, Mg (NO₃)₂, MgCl₂, MgC₂O₄, Mg(tartrate), MgHPO₄, (Mg(NO₃)₂.6 H₂O), (Mg(SO₄).7 H₂O), MgO, (Mg(H₂PO₄)₂), MgHPO₄, (Mg₃(PO₄)₂) or mixtures comprising at least two of them or analog salts of Barium and/or strontium. Also comprises are Hydrates and/or solvates of earth alkalis salts or earth alkali oxides. But also double salts can be used in particular in mixtures such as KMgCl₃.6 H₂O.

Non limiting examples for iv) alkali salts are Li₂CO₃, Li₂SO₄, LiNO₃, LiCl, Li₂C₂O₄, Li₂(tartrate), Li₃PO₄, Li₂SiO₃, or mixtures comprising at least two of them or analog salts of natrium or potassium.

Non limiting examples for useful v) chelating agents are hydroxy-functional organic acids, such as fruit acids or mono-, di-, tri-tetra and/or multi-carbon acid having additional hydroxy-groups as EDTA, tris, citric acid, ascorbic acid, fumaric acid, oxalic acid and other acids known by the skilled person as hydroxy-functional acids.

A particular preferred mineral acids is comprise nitric acid, but other minerals acids are also useful. Preferred are minerals acids, salts and oxides which do not contain halogens, such as chloride, and do not contain sulphate.

In addition further elements or steps in the process may comprise: vi) providing a) a scandium salt or scandium oxide, b) gallium salt or gallium oxide, and/or c) zirconium salt, zirconium oxide, hafnium salt and/or hafnium oxide. Wherein these vi) salts or oxide are also dissolved in the mineral acid in the process.

The educts should be dissolved in a mineral acid in the presence of a sufficient amount of a chelating agent, such as citric acid. For quantitative conversion and a high purity product all educts need to be completely dissolved in the mineral acid. Afterwards the solution is concentrated at elevated temperature to obtain a sol. The sol has to be concentrated to a dried product and the dried product is calcinated to remove organic residues and to form the garnet. Calcination or heating is performed in two steps: a first heating step with heating to above 800° C. is preferred to remove organic residues, such as decomposition products of the chelating agent and the acid. In a second heating step, in particular a calcination step, the garnet is formed at a temperature above 1200° C., in particular above 1500° C., preferred at about 1600° C. Further the garnet may be obtained in a single heating step at elevated temperature above 1500° C. Preferred is a two-step or multi step heating process to obtain garnets with enhanced purity. Heating is performed under air. In an alternative drying and calcination may be performed in a one step process in which the temperature is increased in a defined process or with a defined temperature profile. Also, a multi-step process is possible for heating and/or cooling.

The first heating step at about 600 to 1200° C., in particular at about 900° C.+/−150° C. of the dried product or further product is for 1 to 10 h, preferred over 3 to 5 h. The final heating step, the second heating step, at about 1500 to 1800° C., in particular at about 1600° C.+/−100° C. last 0.5 to 5 h, preferred are 2 to 4 h. Afterwards the product is cooled down. Wherein for each heating or cooling step is a defined heating or cooling rate is used.

The cooling down of the material is preferred performed by cooling down at a rate of 100° C./h to 300° C./h, preferred 200° C./h to 300° C./h.

Heating and cooling down in calcination or heating steps are each independently 100° C./h to 300° C./h, preferred are heating and cooling rates of 300° C./h. Heating and cooling down in calcination step 2 is performed at a rate of 100° C./h to 300° C./h, preferred is a heating and cooling rate of 200° C./h. Particular preferred are linear cooling rates. Calcination is a process in which the reaction mixture, e.g. the mixtures of the educts, more preferred the product with reduced organic content is heated up to a temperature close below the melting temperature, preferred are at least 50 degree, more preferred 100 degree, below the melting point.

A reducing atmosphere may be used in the second heating step using forming gas such as a mixture of N₂ or argon and H₂, e.g. 5 Vol.-% H₂ or 10 Vol.-% H₂ with inert gas up to 100 Vol.-%. Alternative reducing atmospheres may comprise an inertgas such as CH₄ or NH₃.

In a further alternative the garnet or the obtained lanthanide ion doped garnet is milled, in particular the garnet is subjected to tribological impacts in an amount that is sufficient to increase the crystallinity of the garnet in relation to the garnet without subjection to tribological impacts.

Still a further embodiment of the invention is a process, wherein the obtained garnet material is subjected to tribological impacts using as milling material 200 rotation/min (rpm) for 1 to 6 hours, preferred for circa 4 hours. Milling is performed in a planetary ball mill (PM 200, Retsch), g-force up to: 37.1 g, beaker/jar: corundum and grinding balls (Al₂O₃), 50 ml (9 balls, sample ca. 4.5 g) or 125 ml (24 balls, sample ca. 20 g). The grinding beakers/jars are arranged eccentrically on the sun wheel of the planetary ball mill. Direction of movement of the sun wheel is opposite to that of the grinding jars in the ratio 1:−2. The grinding balls in the grinding beakers/jars are subjected to superimposed rotational movements, the so-called Coriolis forces. The difference in speeds between the balls and jars produces an interaction between frictional and impact forces, which releases high dynamic energies.

Preferred the intensity of a main reflex of the obtained garnet doped with lanthanide ion can be increased by a milling step at least by 25%, in particular by 30%, more preferred by at least 40%, 50%, 60%, 70% or 80%. For the garnet the intensity of a main reflex in the range of 31° 2Θ to 35° 2Θ may be increased by at least 20%, in particular by 50%, more preferred by at least 60%. Preferably, this milling step is the first milling step in the process to reduce particle size and to reduce undesired phases in the solid.

Still a further embodiment is a garnet doped with lanthanide ions for converting electromagnetic radiation energy of a longer wavelength to electromagnetic radiation energy of shorter wavelength, obtainable according to the described process, wherein the garnet is doped with lanthanide ions selected from praseodymium, gadolinium, erbium, neodymium and for co-doping at least two of them, and, wherein the garnet doped with lanthanide ions is selected from lutetium-aluminium garnet, yttrium-aluminium garnet (YAG), silicate garnet and an aluminium-silicate garnet.

Subject of the invention is also a garnet doped with lanthanide ion for converting electromagnetic radiation energy of a longer wavelength to electromagnetic radiation energy of shorter wavelength or a mixture of garnets, obtainable according to the process of invention, wherein
the garnet is doped with lanthanide ions selected from praseodymium(III+), gadolinium(III+), erbium(III+), neodymium(III+) and co-doping comprising at least two of them, preferred is praseodymium(III+) optionally co-doped with gadolinium(III+) and,

wherein the crystallinity of the garnet is greater than 80%, in particular the crystallinity of the garnet is more or equal than 80%, more or equal than 85%, 90%, 95%, more or equal 98%, 99%, 99.5%, 99.8%, and optionally wherein electromagnetic radiation energy of at least one longer wavelength of below 530 nm, in particular in the range of 490 to 450 nm, is converted to electromagnetic radiation energy of at least one shorter wavelength in the range of 220 to 400 nm, in particular in the range of 275 to 350 nm.

Wherein the longer wavelength is per definition always longer than the shorter wavelength.

According to a further embodiment a composition, foil or film comprising garnets is disclosed for self-disinfection purposes or for reduction of microorganisms.

Subject of the invention is also the use of a garnet doped with lanthanide ion in UV sterilization or disinfection applications, in indoor UV sterilization applications, in particular indoor UV sterilization application utilizing electromagnetic radiation energy from LEDs, in particular pcLEDs, comprising emission maxima in the range of 450 to 480 nm.

### EMBODIMENTS

### Measurement Techniques

The X-ray diffractograms were recorded by using a Panalytical X'Pert PRO MPD diffractometer working in Bragg-Brentano geometry using Cu-Kα radiation and a line-scan CCD sensor. The integration time amounted to 20 s with a step size of 0.017°.

Emission spectra were recorded on an Edinburgh Instruments FLS920 spectrometer equipped with a 488 nm continuous-wave OBIS Laser by Coherent and a Peltier cooled (−20° C.) single-photon counting photomultiplier (Hamamatsu R2658P). Filters were used to suppress excitation by second order reflexes caused by the monochromators.

Emission spectra is excited with a laser, in particular a laser with an efficiency of 75 mW at 445 nm and/or an efficiency of 150 mW at 488 nm.

Milling is performed in a planetary ball mill (PM 200, Retsch), beaker/jar: corundum and grinding balls (Al₂O₃), 50 ml (9 balls, sample ca. 4.5 g) or 125 ml (24 balls, sample ca. 20 g) for 4 hours at 200 rotation/min after cooling of the final calcination step. Reducing atmosphere (H₂/Inertgas, in particular H₂/N₂, preferred (H₂ (5%)/N₂ (95%)).

### Powder Sample Synthesis

### Comparative Example

As comparative example other lanthanide doped silicate systems disclosed in the below mentioned publication were produced and measured under same conditions (Visible-to-UVC up-conversion efficiency and mechanisms of Lu₇O₆F₉:Pr³⁺ and Y₂SiO₅:Pr³⁺ ceramics, Cates, Ezra L.; Wilkinson, Angus P.; Kim, Jae-Hong, Journal of Luminescence 160 (2015) 202-209; Abstract: Visible-to-UVC up-conversion (UC) by Pr³⁺-doped materials is a promising candidate for application to sustainable disinfection technologies, including light-activated antimicrobial surfaces and solar water treatment. In this work, we studied Pr³⁺ up-conversion in an oxyfluoride host system for the first time, employing Lu₇O₆F₉:Pr³⁺ ceramics. Compared to the previously studied Y₂SiO₅:Pr³⁺ reference material, the oxyfluoride host resulted in a 5-fold increase in intermediate state lifetime, likely due to a lower maximum phonon energy; however, only a 60% gain in UC intensity was observed. To explain this discrepancy, luminescence spectral distribution and decay kinetics were studied in both phosphor systems. The Pr³+4f5d band energy distribution in each phosphor was found to play a key role by allowing or disallowing the occurrence of a previously unexplored UC mechanism, which had a significant impact on overall efficiency.

Lu₇O₆F₉:Pr³⁺: Could not be obtained under disclosed temperature and a synthesis under increased temperature and a pressure of 350 MPa was not able due to the availability of a temperable press.

Y₂SiO₅:Pr³⁺ was as synthesized according to the publication as a pure phase (Emission spectra see FIG. 1).

### Powder Synthesis

### Example 1: (Lu_{0.99}Pr_{0.01})₃Al₅O₁₂

2.3637 g (5.9400 mmol) Lu₂O₃, 0.0204 g (0.0200 mmol) Pr₆O₁₁, 7.5027 g (20.0000 mmol) Al(NO₃)₃.9H₂O and 7.7530 g (64.0000 mmol) tris(hydroxymethyl)aminomethane were dissolved in dilute nitric acid. After concentrating the mixtures by slow evaporation at 65° C. under vigorous stirring, the sol turned into a transparent, highly viscous gel. The temperature was subsequently raised to 300° C. to start the self-sustaining gel combustion process, which was accompanied by the development of a large amount of gas. The intermediate product was dried at 150° C. over night. To remove organic residues, the dried powder was calcined at 800° C. for four hours in air. A final calcination step at 1600° C. for four hours in air was carried out to obtain the product phase.

### Example 2: (Lu_{0.985}Pr_{0.015})₂CaAl₄SiO₁₂

1.5679 g (3.9400 mmol) Lu₂O₃, 0.0204 g (0.0200 mmol) Pr₆O₁, 0.4003 g (4.0000 mmol) CaCO₃, 6.0021 g (16.0000 mmol) Al(NO₃)₃.9H₂O, 0.8333 g (4.0000 mmol) Si(OC₂H₅)₄ and 15.6905 g (81.6680 mmol) citric acid were dissolved in dilute nitric acid. The solution was stirred vigorously at 65° C. to obtain a sol. The sol was dried at 150° C. over night to turn it into a gel. Subsequent calcination at 800° C. in a muffle furnace for four hours in air removed organic residues. A further calcination step at 1600° C. for four hours in air was performed to obtain the product phase.

### Example 3: (Lu_{0.99}Pr_{0.01})₃Ga₂Al₃O₁₂

2.3637 g (5.9400 mmol) Lu₂O₃, 0.0204 g (0.0200 mmol) Pr₆O₁, 4.5016 g (12.0000 mmol) Al(NO₃)₃.9H₂O, 3.7754 g (8.0000 mmol) Ga(NO₃)₃.12H₂O and 7.7530 g (64.0000 mmol) tris(hydroxymethyl)aminomethane were dissolved in dilute nitric acid. After concentrating the mixtures by slow evaporation at 65° C. under vigorous stirring, the sol turned into a transparent, highly viscous gel. The temperature was subsequently raised to 300° C. to start the self-sustaining gel combustion process, which was accompanied by the development of a large amount of gas. The intermediate product was dried at 150° C. over night. To remove organic residues, the dried powder was calcined at 800° C. for four hours in air. A final calcination step at 1600° C. for four hours in air was carried out to obtain the product phase.

### Example 4: (Lu_{0.99}Pr_{0.01})₃ScAl₄O₁₂

2.3637 g (5.9400 mmol) Lu₂O₃, 0.0204 g (0.0200 mmol) Pr₆O₁, 5.1374 g (16.0000 mmol) Al(NO₃)₃.9H₂O and 15.6905 g (81.6680 mmol) citric acid were dissolved in dilute nitric acid. 0.5516 g (4.0000 mmol) Sc₂O₃ were dispersed in the aforementioned solution. The solution was stirred vigorously at 65° C. to obtain a sol. The sol was dried at 150° C. over night to turn it into a gel. Subsequent calcination at 800° C. in a muffle furnace for four hours in air removed organic residues. A further calcination step at 1600° C. for four hours in air was performed to obtain the product phase.

### Example 5: (Lu_{0.99}Pr_{0.01})₂LiAl₃Si₂O₁₂

3.1516 g (7.9200 mmol) Lu₂O₃, 0.0272 g (0.0267 mmol) Pr₆O₁₁, 9.0032 g (24.0000 mmol) Al(NO₃)₃.9H₂O, 0.2956 g (4.0000 mmol) Li₂CO₃, 3.3333 g (16.0000 mmol) Si(OC₂H₅)₄ and 40.3470 g (192.0000 mmol) citric acid were dissolved in dilute nitric acid. The solution was stirred vigorously at 65° C. to obtain a sol. The sol was dried at 150° C. over night to turn it into a gel. Subsequent calcination at 1000° C. in a muffle furnace for four hours in air removed organic residues. A further calcination step at 1600° C. for one hour in air was performed to obtain the product phase.

### Example 6: (Lu_{0.89}Pr_{0.01}Gd_{0.1})₂Ca₂Al₄SiO₁₂

1.4875 g (3.7380 mmol) Lu₂O₃, 0.1522 g (0.4200 mmol) Gd₂O₃, 0.9918 g (4.2000 mmol) Ca(NO₃)₂.4H₂O, 6.3022 g (16.8000 mmol) Al(NO₃)₃.9H₂O, 0.0365 g (0.0840 mmol) Pr(NO₃)₃.6H₂O, 0.8750 g (4.2000 mmol) Si(OC₂H₅)₄ and 21.1822 g (100.8000 mmol) citric acid were dissolved in dilute nitric acid. The solution was stirred vigorously at 65° C. to obtain a sol. The sol was dried at 150° C. over night to turn it into a gel. Subsequent calcination at 800° C. in a muffle furnace for four hours in air removed organic residues. A further calcination step at 1600° C. for four hours in air was performed to obtain the product phase.

### Example 7: Ca₂(Lu_{0.99}Pr_{0.01})Sc₂GaSi₂O₁₂

1.1819 g (2.9700 mmol) Lu₂O₃, 0.8275 g (6.0000 mmol) Sc₂O₃, 0.0083 g (0.0082 mmol) Pr₆O₁₁, 1.2010 g (12.0000 mmol) CaCO₃, 2.5000 g (12.0000 mmol) Si(OC₂H₅)₄ and 30.2602 g (144.0000 mmol) citric acid were dissolved in dilute nitric acid. The solution was stirred vigorously at 65° C. to obtain a sol. The sol was dried at 150° C. over night to turn it into a gel. Subsequent calcination at 1000° C. in a muffle furnace for four hours in air removed organic residues. A further calcination step at 1400° C. for one hour in air was performed to obtain the product phase.

### DESCRIPTION OF FIGURES

FIG. 1: Emission spectrum of Y₂SiO₅:Pr³⁺ upon excitation at 445 nm and 488 nm.

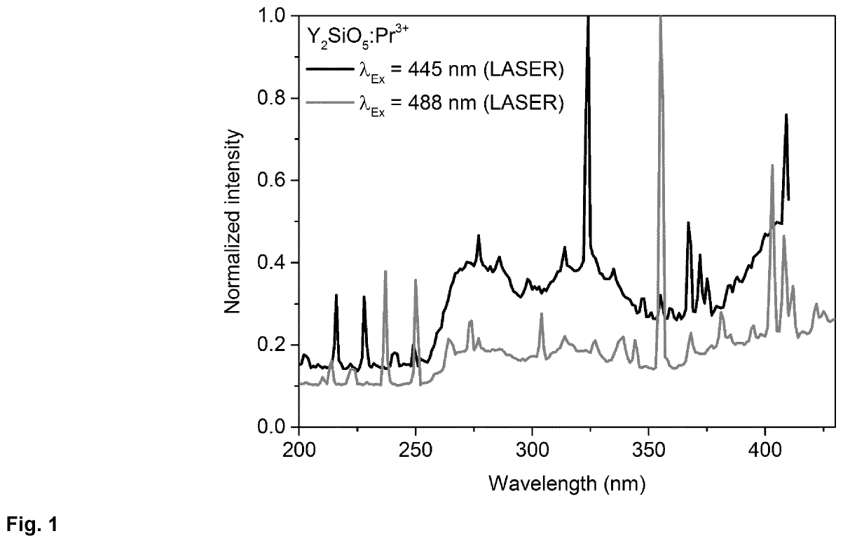

FIG. 2: X-ray diffraction pattern of (Lu_{0.99}Pr_{0.01})₃Al₅O₁₂ for Cu—K_{α} radiation (Example 1).

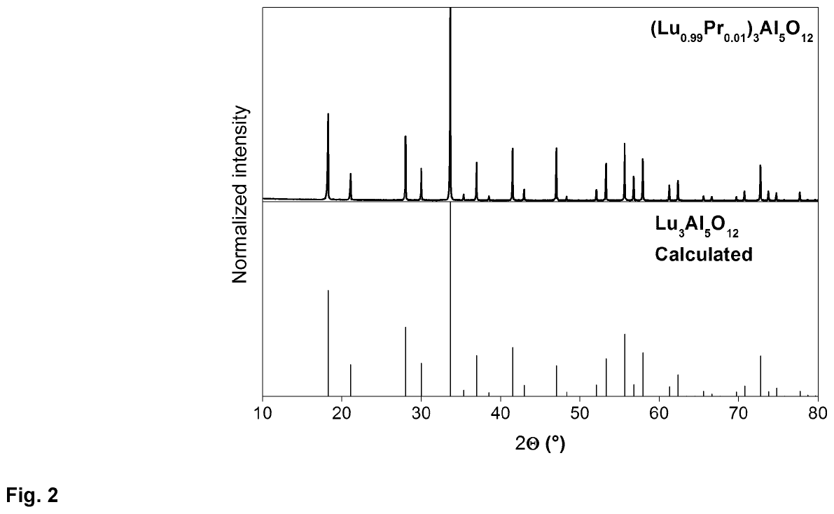

FIG. 3: X-ray diffraction pattern of (Lu_{0.985}Pr_{0.015})₂CaAl₄SiO₁₂ for Cu—K_{α} radiation (Example 2).

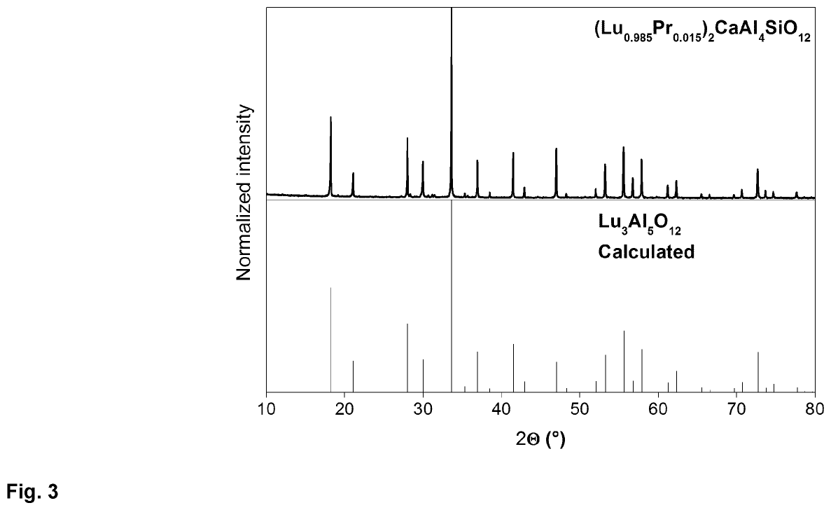

FIG. 4: X-ray diffraction pattern of (Lu_{0.99}Pr_{0.01})₃Ga₂Al₃O₁₂ for Cu—K_{α} radiation (Example 3).

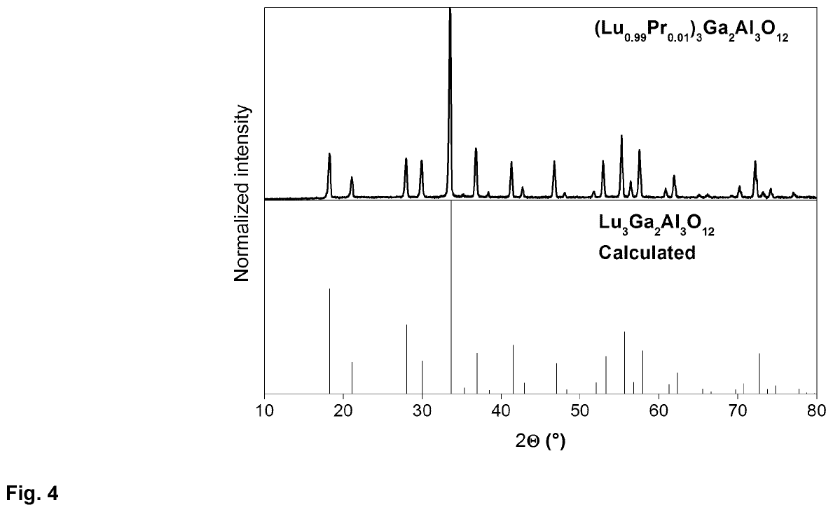

FIG. 5: X-ray diffraction pattern of (Lu_{0.99}Pr_{0.01})₃ScAl₄O₁₂ for Cu—K_{α} radiation (Example 4).

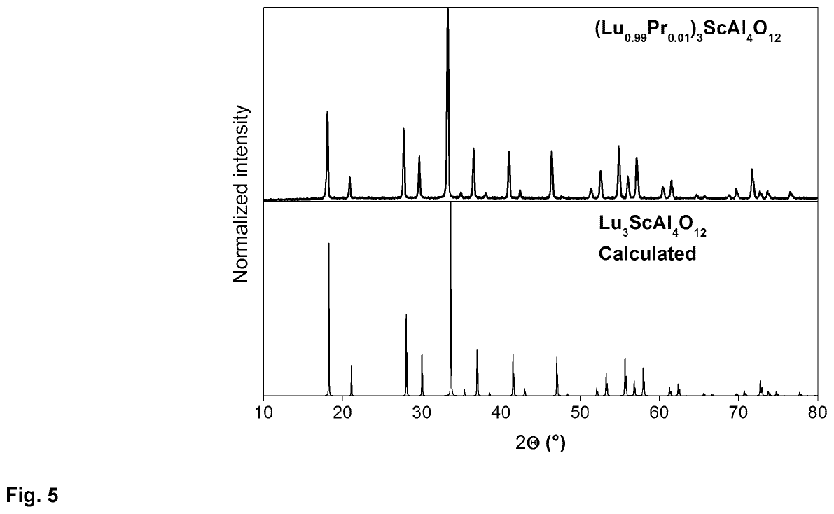

FIG. 6: X-ray diffraction pattern of (Lu_{0.99}Pr_{0.01})₂LiAl₃Si₂O₁₂ for Cu—K_{α} radiation (Example 5).

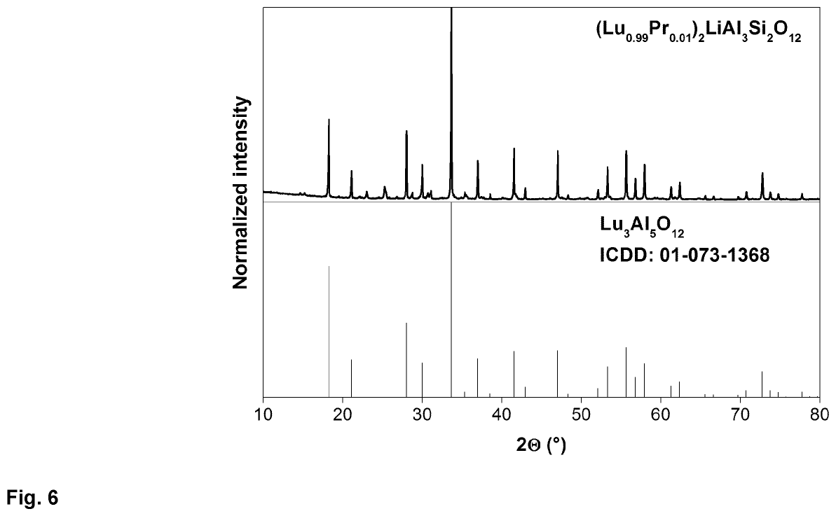

FIG. 7: Emission spectrum of (Lu_{0.99}Pr_{0.01})₃Al₅O₁₂ upon excitation at 488 nm (Example 1).

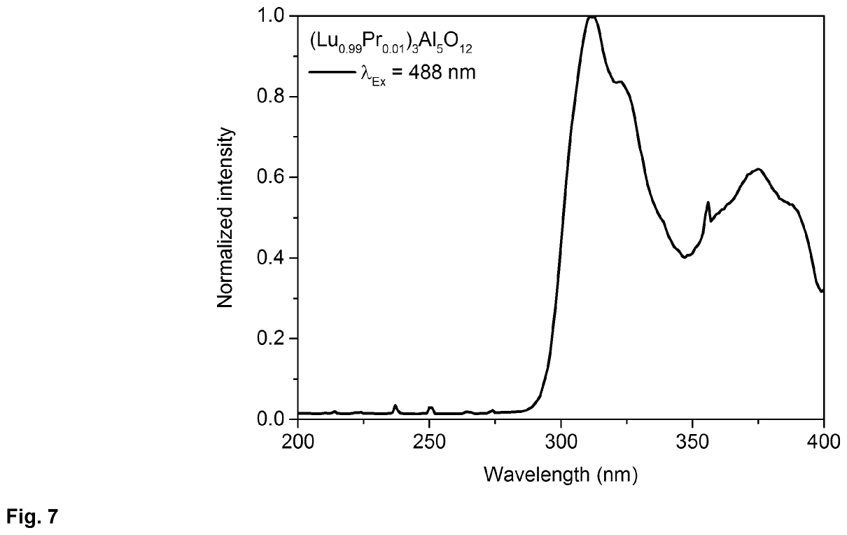

FIG. 8: Emission spectrum of (Lu_{0.985}Pr_{0.015})₂CaAl₄SiO₁₂ upon excitation at 445 nm (Example 2).

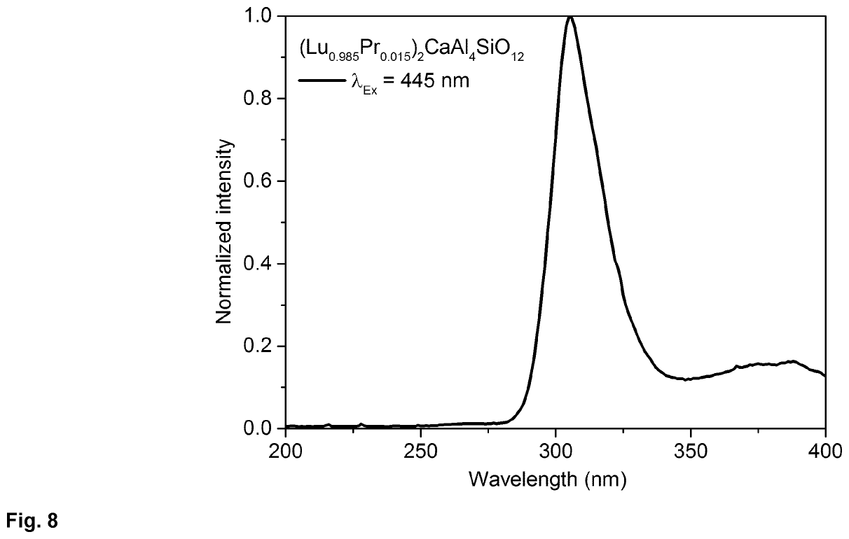

FIG. 9: Emission spectrum of (Lu_{0.99}Pr_{0.01})₃Ga₂Al₃O₁₂ upon excitation at 488 nm (Example 3).

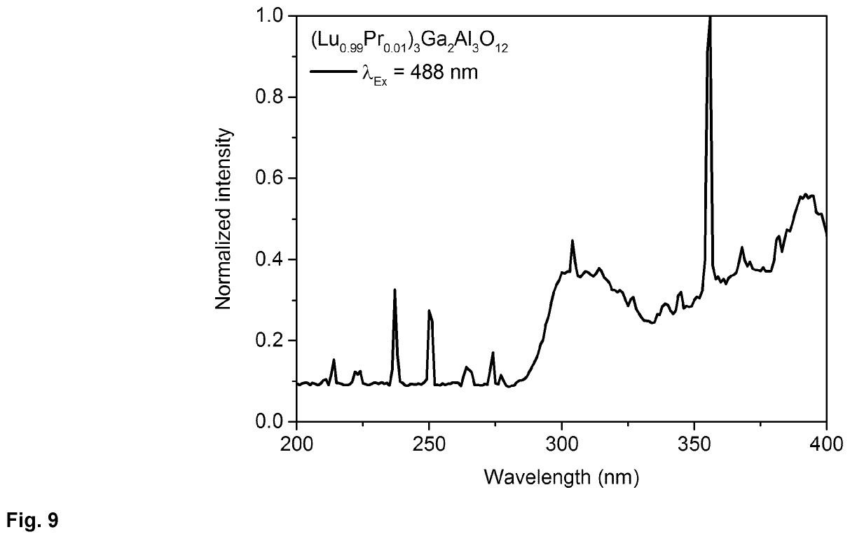

FIG. 10: Emission spectrum of (Lu_{0.99}Pr_{0.01})₃ScAl₄O₁₂ upon excitation at 445 nm (Example 4).

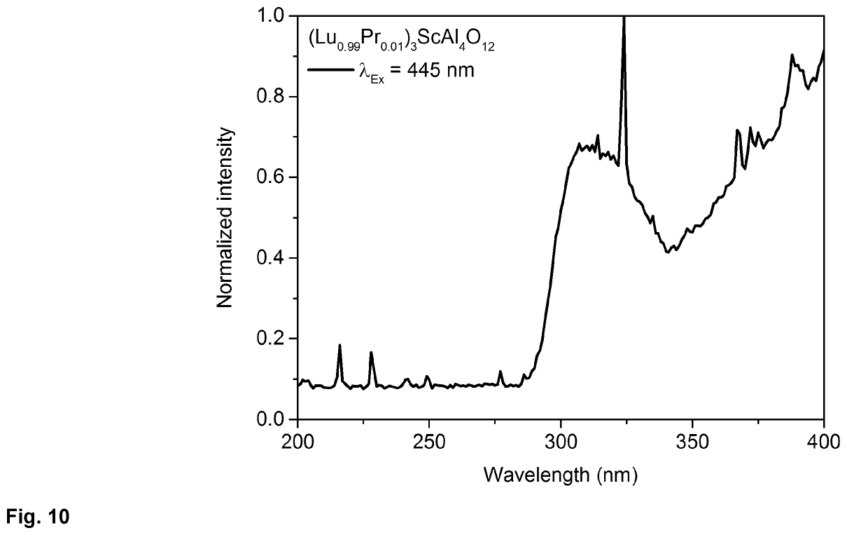

FIG. 11: Emission spectrum of (Lu_{0.99}Pr_{0.01})₂LiAl₃Si₂O₁₂ upon excitation at 488 nm (Example 5).

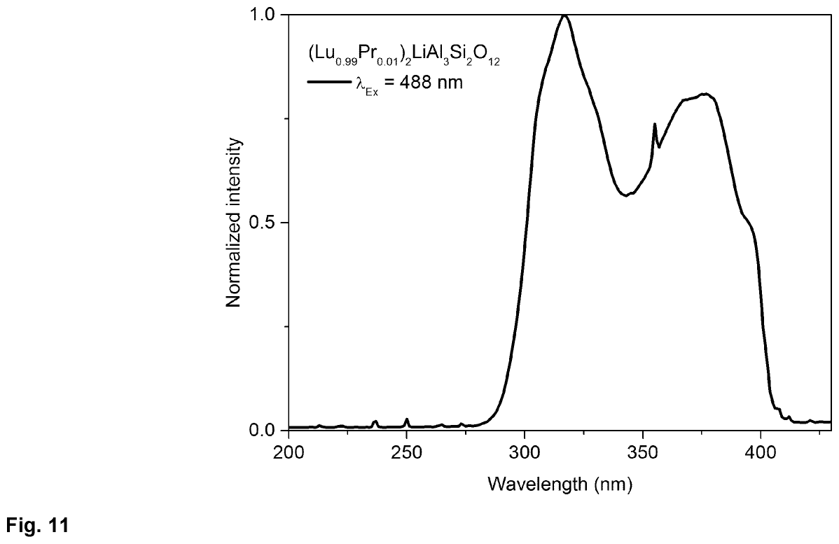

FIG. 12: Emission spectrum of (Lu_{0.99}Pr_{0.01})₃Al₅O₁₂ and the germicidal action curve for E. coli (DIN 5031-10).

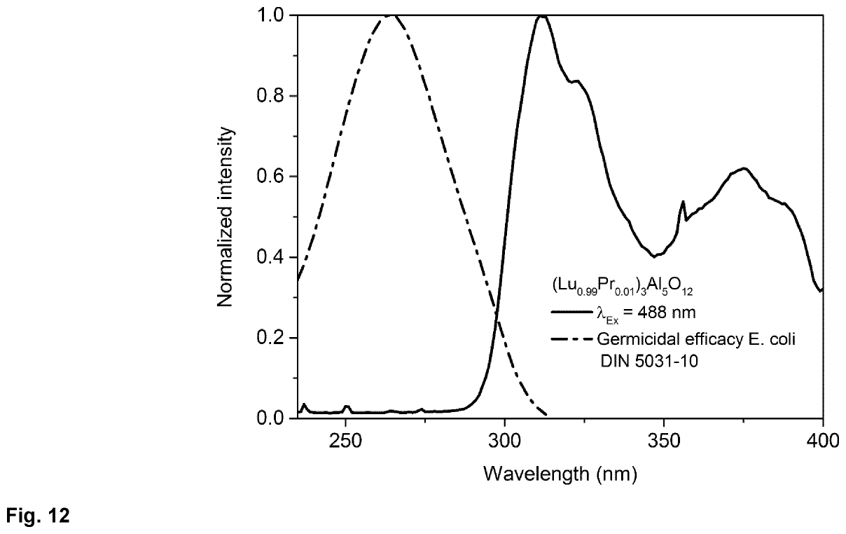

FIG. 13: Emission spectrum of (Lu_{0.985}Pr_{0.015})₂CaAl₄SiO₁₂ and germicidal action curve for E. coli (DIN 5031-10).

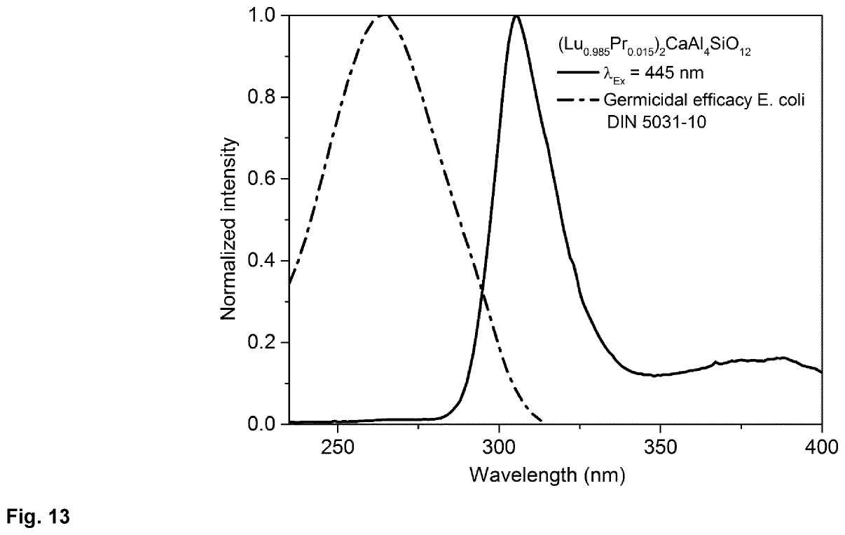

FIG. 14a: X-ray diffraction pattern of (Lu_{0.89}Pr_{0.01}Gd_{0.1})₂Ca₂Al₄SiO₁₂ for Cu—K_{α} radiation (Example 6).

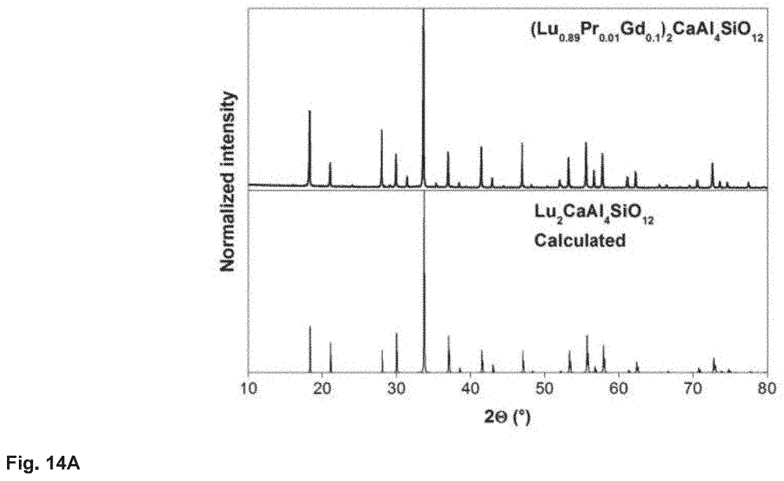

FIG. 14b: Emission spectrum of (Lu_{0.89}Pr_{0.01}Gd_{0.1})₂Ca₂Al₄SiO₁₂ upon excitation at 445 nm (Example 6).

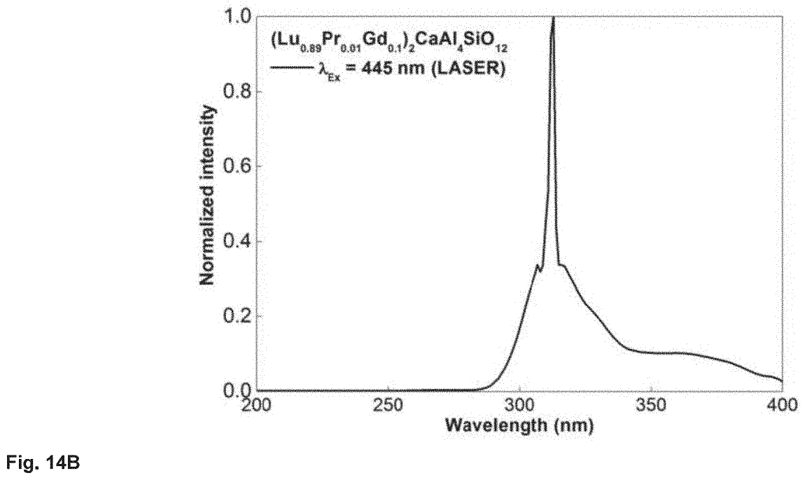

FIG. 15a: X-ray diffraction pattern of Ca₂(Lu_{0.99}Pr_{0.01})Sc₂GaSi₂O₁₂ for Cu—K_{α} radiation (Example 7).

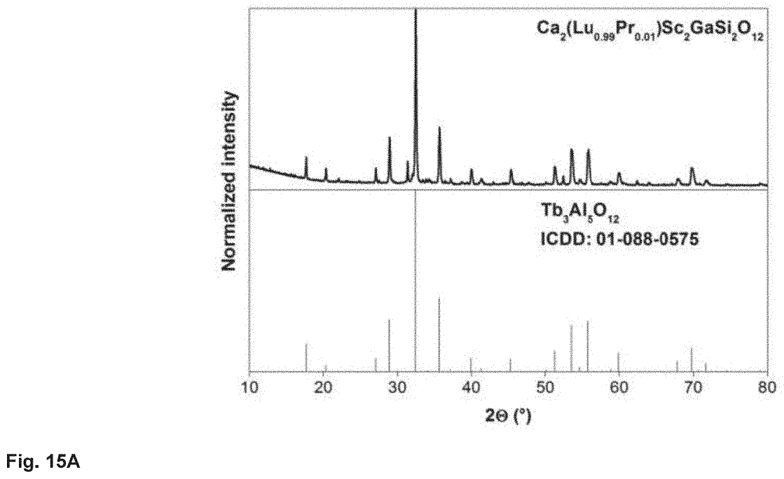

FIG. 15b: Emission spectrum of Ca₂(Lu_{0.99}Pr_{0.01})Sc₂GaSi₂O₁₂ upon excitation at 445 nm (Example 7). The garnet possesses a range of emission from 280 to 400 nm with a maximum at 310 nm.

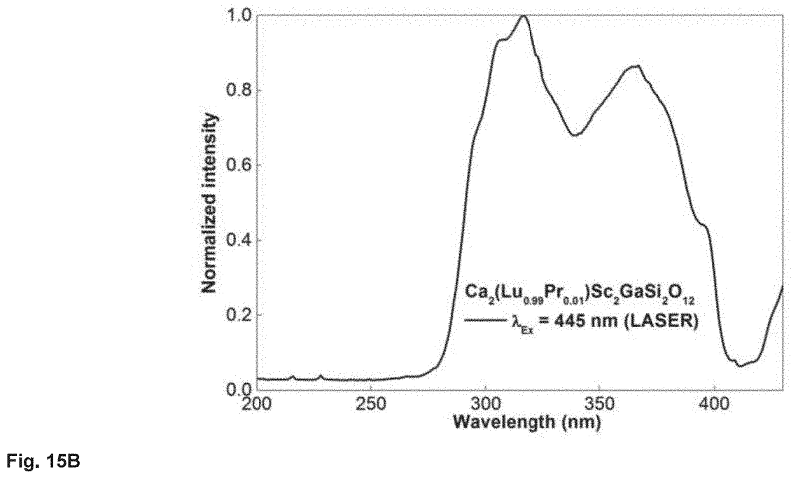

1: A garnet, doped with at least one lanthanide ion selected from the group consisting of praseodymium, gadolinium, erbium, neodymium, and, yttrium.

2: The garnet according to claim 1, wherein
the garnet comprises lutetium on a position of a crystal lattice, wherein the position in the crystal lattice is doped with the at least one lanthanide ion selected from the group consisting of praseodymium, gadolinium, erbium, neodymium, and yttrium, or
the garnet is a lutetium-aluminium garnet that is doped with the at least one lanthanide ion selected from the group consisting of praseodymium, gadolinium, erbium, and neodymium, or
the garnet is a yttrium-aluminium garnet (YAG) that is doped with the at least one lanthanide selected from the group consisting of praseodymium, gadolinium, erbium, neodymium, and yttrium, or
the garnet is a silicate garnet or an aluminium-silicate garnet that is doped with the at least one lanthanide ion selected from the group consisting of praseodymium, gadolinium, erbium, neodymium, and yttrium;
wherein if the garnet is doped with more than one lanthanide ion, each lanthanide ion of the at least one lanthanide ion is different from another.

3: The garnet according to claim 1, wherein the at least one lanthanide ion is selected from the group consisting of praseodymium(III+), gadolinium(III+), erbium(III+), and neodymium(III+); and wherein if the garnet is doped with more than one lanthanide ion, the garnet is doped with a second lanthanide(III+) ion selected from the group consisting of praseodymium(III+), gadolinium(III+), erbium(III+), neodymium(III+), and yttrium(III+), wherein the second lanthanide(III+) ion is different from the at least one lanthanide ion.

4: The garnet according to claim 3, wherein the at least one lanthanide ion is praseodymium(III+), and wherein if the garnet is doped with more than one lanthanide ion, the garnet is doped with the second lanthanide(III+) ion.

5: The garnet according to claim 1, wherein the garnet converts electromagnetic radiation energy of a longer wavelength to electromagnetic radiation energy of a shorter wavelength.

6: The garnet according to claim 1, wherein the garnet is not a hydrate, and/or the garnet is free from hydroxyl-groups.

7: The garnet according to claim 1, wherein a crystallinity of the garnet is greater than 70%.

8: The garnet according to claim 1, wherein the garnet has the general formula I
Lu_{3-a-b-n}Ln_{b}(Mg_{1-z}Ca_{z})ₐLiₙ(Al₁₋ᵤ₋ᵥGaᵤScᵥ)₅₋ₐ₋₂ₙ(Si_{1-d-e}Zr_{d}Hfₑ)ₐ₊₂ₙO₁₂ I
wherein a=0-1, 1≥b>0, d=0-1, e=0-1, n=0-1, z=0-1, u=0-1, v=0-1, with u+v≤1 and d+e≤1; and
wherein Ln=praseodymium (Pr), gadolinium (Gd), erbium (Er) neodymium (Nd), or yttrium (Y).

9: The garnet according to claim 1, wherein the garnet has the general formula Ia
(Lu_{1-x-y}YₓGd_{y})_{3-a-b-n}Ln_{b}(Mg_{1-z}Ca_{z})ₐLiₙ(Al₁₋ᵤ₋ᵥGaᵤScᵥ)₅₋ₐ₋₂ₙ(Si_{1-d-e}Zr_{d}Hfₑ)ₐ₊₂ₙO₁₂ Ia
wherein a=0-1, 1≥b>0, d=0-1, e=0-1, n=0-1, x=0-1, y=0-1, z=0-1, u=0-1, v=0-1, with x+y=1, u+v≤1 and d+e≤1;
wherein in formula Ia, Ln=praseodymium (Pr), erbium (Er), or neodymium (Nd).

10: The garnet according to claim 1, wherein the garnet has one of the following general formulas:
formula Ib
(Lu_{1-x-y}YₓGd_{y})_{3-b}Ln_{b}(Al₁₋ᵤ₋ᵥGaᵤScᵥ)₅O₁₂ Ib
wherein in formula Ib, Ln_{b} is Ln=Pr and b=0.001-0.05, x=0-1, y=0-1, u=0-1, v=0-1,
formula Ic
(Lu_{1-x-y}YₓGd_{y})_{3-b-a}Ln_{b}(Mg_{1-z}Ca_{z})_{a+b}Al_{5-a-b}Si_{a+b}O₁₂ Ic
wherein in formula Ic, Ln_{b} is Ln=Pr, 1≥b>0, a>0, x=0-1, y=0-1, z=0-1,
formula Id
(Lu_{1-x-y}YₓGd_{y})_{2-b}Ln_{b}(Ca_{1-z}Mg_{z})Al₄(Zr_{1-f}Hfᵣ)O₁₂ Id
wherein in formula Id, Ln_{b} is Ln=Pr, b>0, x=0-1, y=0-1, z=0-1, f=0-1, and
formula Id*
(Lu_{1-x-y}YₓGd_{y})_{1-b}Ln_{b}(Ca_{1-z}Mg_{z})₂Al₃(Zr_{1-f}Hf_{f})₂O₁₂ Id*
wherein in formula Id*, Ln_{b} is Ln=Pr, 0.5≥b>0, x=0-1, y=0-1, z=0-1, f=0-1.

11: The garnet according to claim 1, wherein the garnet has one of the following general formulas:
(Lu_{1-x-y}YₓGd_{y})_{3-b}Pr_{b}(Al₁₋ᵤGaᵤ)_{5-b}O₁₂,
(Lu_{1-x-y}YₓGd_{y})_{3-b}Pr_{b}(Al₁₋ᵤScᵥ)_{5-b}O₁₂,
(Lu_{1-x-y}YₓGd_{y})_{3-b}Pr_{b}(Ga₁₋ᵤScᵥ)₅O₁₂,
(Lu_{1-x-y}YₓGd_{y})₂Pr_{b}CaAl₄SiO₁₂,
(Lu_{1-x-y}YₓGd_{y})Pr_{b}Ca₂Al₃Si₂O₁₂,
(Lu_{1-x-y}YₓGd_{y})₂Pr_{b}MgAl₄SiO₁₂,
(Lu_{1-x-y}YₓGd_{y})Pr_{b}Mg₂Al₃Si₂O₁₂,
(Lu_{1-x-y}YₓGd_{y})₂Pr_{b}CaAl₄(Zr_{d}Hfₑ)O₁₂,
(Lu_{1-x-y}YₓGd_{y})Pr_{b}Ca₂Al₃(Zr_{d}Hfₑ)₂O₁₂,
(Lu_{1-x-y}YₓGd_{y})₂Pr_{b}MgAl₄(Zr_{d}Hfₑ)O₁₂,
(Lu_{1-x-y}YₓGd_{y})Pr_{b}Mg₂Al₃(Zr_{d}Hfₑ)₂O₁₂,
wherein b=0.001-0.05, u=0-1, v=0-1, x=0-1, y=0-1.

12: The garnet according to claim 1, wherein the garnet is a solid solution doped z with lanthanide ions comprising at least one earth alkali on and/or at least one alkali ion.

13: The garnet according to claim 1, wherein the garnet converts electromagnetic radiation energy of a longer wavelength of below 500 nm to electromagnetic radiation energy of shorter wavelengths in the range of 230 nm to 400 nm.

14: A process for the production of the garnet according to claim 1, the process comprising:
dissolving the following components i), ii), v), and optionally, iii) and/or iv), in acid,
i) at least one first lanthanide salt and/or lanthanide oxide,
wherein a lanthanide ion in the at least one first lanthanide oxide and/or lanthanide salt is selected from the group consisting of praseodymium, gadolinium, erbium, neodymium, and a mixture thereof,
ii) at least an element for a crystal garnet lattice selected from the group consisting of
a) at least one second lanthanide salt or lanthanide oxide,
b) an Si source,
c) an aluminium source, and
d) yttrium salt or yttrium oxide or a mixture thereof,
iii) optionally, at least one earth alkali salt and/or earth alkali oxide, and/or
iv) optionally, at least one alkali salt, and
v) a chelating agent,
evaporating the of acid and, optionally, the chelating agent at an elevated temperature, optionally under stirring, to obtain a concentrated reaction product,
drying the concentrated reaction product by heating the concentrated reaction product above 100° C., to obtain a further product,
heating up the further product to at least 600° C. for 1 to 10 h, to remove organic residues and to obtain a product with reduced organic content,
heating the product with reduced organic content up to at least 1200° C. for 0.5 to 10 h,
cooling down the product with reduced organic content, and
obtaining the garnet.

15: The process according to claim 14, wherein at least one further salt and/or oxide is dissolved in the acid, wherein the at least one further salt and/or oxide is
a scandium salt or scandium oxide,
a gallium salt or gallium oxide, and/or
a zirconium salt, zirconium oxide, hafnium salt, and/or hafnium oxide.

16: A garnet doped with the at least one lanthanide ion for converting electromagnetic radiation energy of a longer wavelength to electromagnetic radiation energy of shorter wavelength, obtainable according to the process of claim 14, wherein the game is doped with the at least one lanthanide ion selected from the group consisting of praseodymium, gadolinium, erbium, and neodymium, and
wherein the garnet is one selected from the group consisting of a lutetium-aluminium garnet, a yttrium-aluminium garnet (YAG), a silicate garnet, and an aluminium-silicate garnet.

17: A garnet doped with the at least one lanthanide ion for converting electromagnetic radiation energy of a longer wavelength to electromagnetic radiation energy of shorter wavelength, obtainable according to the process of claim 14, wherein the garnet is doped with the at least one lanthanide ion selected from the group consisting of praseodymium, gadolinium, erbium, and neodymium, and
wherein the garnet comprises above 95% of Ln³⁺ lanthanide ions and less than 5% of Ln⁴⁺ lanthanide ions, in respect to all Ln ions (sum up to 100%).

18: A composition, foil or film, comprising the garnet according to claim 1 for self-disinfection purposes or for reduction of microorganisms.

19: A method, comprising:
adding the garnet according to claim 1 into a coating composition or a material to provide a coating or surface that is able to inactivate microorganisms or cells covering the coating or surface under exposure of electromagnetic radiation energy of a longer wavelength of below 500 nm.

20: The process according to claim 14, wherein the at least one first lanthanide salt and/or lanthanide oxide is selected from the group consisting of lanthanide nitrate, lanthanide carbonate, lanthanide carboxylate, lanthanide acetate, lanthanide sulphate, lanthanide oxide, and a mixture thereof; and/or
wherein the at least one second lanthanide salt or lanthanide oxide is selected from the group consisting of lanthanide nitrate, lanthanide carbonate, lanthanide carboxylate, lanthanide acetate, lanthanide sulphate, lanthanide oxide, and a mixture thereof.
